(19) United States
(12) Patent Application Publication
(10) Pub. No.: US 2019/0138034 A1
(43) Pub. Date: May 9, 2019

(54) WATER LEVELING AND FILTERING SYSTEM

(71) Applicant: Cecil Holt, Douglas, GA (US)

(72) Inventor: Cecil Holt, Douglas, GA (US)

(21) Appl. No.: 15/981,850

(22) Filed: May 16, 2018

Related U.S. Application Data
(60) Provisional application No. 62/506,920, filed on May 16, 2017.

(51) Int. Cl. G05D 9/02; E02B 8/06; C02F 1/00

(52) U.S. Cl. CPC G05D 9/02; C02F 2103/007; C02F 1/004; E02B 8/06

(57) ABSTRACT

A water leveling and filtering system having a guard. The guard includes a sleeve or gate to provides for the flow of water through a drainage opening. The guard includes a floatation means. The guard floats and rises along the elongate path of the drain pipe or drain opening as the water level rises, thereby preventing debris from entering the top of the pipe. The guard includes openings therein that continue to allow water to enter the overflow pipe when the water rises while protecting the opening to the drainage system from debris entering.

### PRIORITY CLAIM

This patent application claims benefit and priority of U.S. Provisional Patent Application Ser. No. 62/506,920 by applicant Cecil Holt filed on May 16, 2017.

### FIELD OF INVENTION

This invention relates to the filtering of water during pond overflow or water drainage and, more particularly, to a water leveling and filing system and apparatus that includes a floating sleeve that is suitable for the ponds, lakes, and other water drainage and trash filtering applications.

### BACKGROUND OF THE INVENTION

### Background

There is a continuing need for ponds, lakes and municipal drainage systems to be cleared of debris that enters the water. During the flow of such systems, the debris tends to accumulate and potentially block the drainage of the system. A trash rack is designed to keep water-borne trash and debris from entering a water conveyance such as an overflow pipe, standpipe or spillway. In a storm drain inflow or outflow, a trash rack may be installed to prevent debris from entering a natural watercourse. Manufacturers make these trash racks of wood, metal or plastic such as polyethylene. Trash racks composed of vertical wooden strakes separated by narrow gaps or sturdier metal gratings with narrower strakes are common. The angling of the trash rack can allow for some self-cleaning from the action of the water, but further maintenance or cleaning measures are often needed. Modern trash racks as used by hydroelectric plants can incorporate such advanced features as wedge-wire screens, the Coanda effect, and cleaning robots. However, these expensive systems are not viable for a pond or municipal street drain.

Blockages of an overflow pipe or spillway cause particular problems in maintaining the level of water systems and can cause a system to overflow. In the case of a street or a pond bank, the water overflow can result in catastrophe. Further, a blockage can cause a system to accumulate more debris and pollute the water system beyond acceptable levels.

A need exists for improvements to current draining systems to address this need for better draining and filtering of debris from water, while maintaining the level of the water system.

### SUMMARY OF THE PRESENT INVENTION

Accordingly, the overall objective of this invention is to provide a novel water leveling and filtering system with a floating sleeve.

The present apparatus comprises a debris trap with a guard. In a preferred embodiment, the guard comprises a sleeve with a top and bottom. A portion of the bottom or sides of the sleeve are open or include channels, strakes, or other perforations of the sleeve to provide for the flow of water from the bottom portion of the sleeve upward through the trap sleeve to the top of a drain opening in a pipe or spillway. The sleeve floats about the drainage pipe whereby the interior chamber of the sleeve covers the opening of the pipe. Alternatively, the guard provides a gate that fills the opening of the drainage way. The sleeve or gate floats along an upper portion of the pipe or drainage way length to prevent exposure of the top of the drain to overflowing water without filtering of debris. A filter may be attached near the upper portion of the sleeve where the sleeve is about the top of a pipe. The filter prevents any smaller debris that passes through the sleeve from entering the pipe. The sleeve rises along the vertical length of the pipe as the water level rises, thereby preventing debris from entering the top of the pipe. The combination of the sleeve and filter continues to allow water to enter the top of the pipe when the water rises. When the water level about the sleeve, pipe, and filter is low, operators may collect and remove debris.

### BRIEF DESCRIPTION OF THE FIGURES

FIG. 1 is a front right-side perspective view of an embodiment of a water level and filtering system of the present invention with a portion of a pipe cut-away.

FIG. 2 is a side plan view of the water level and filtering system according to the embodiment of FIG. 1 illustrating use in maintaining water level.

FIG. 3 is a side plan view of the water level and filtering system according to an embodiment of the invention.

FIG. 4 is a side plan view of a filter used in the water level and filtering system according to an embodiment of the invention.

FIG. 5A is a side plan view of an embodiment of a fitting for the filter of FIG. 4 for attachment of the filter to a pipe of varying size according to an embodiment of the invention.

FIG. 5B is a side plan view of an embodiment of an alternative fitting for the filter of FIG. 4 for attachment of the filter to a pipe of varying size according to an embodiment of the invention.

FIG. 6 is a schematic view of a water level and filtering system according to another embodiment of the present invention used in a roadway drainage system with a spillway.

FIG. 7 is a front plan view of a water level and filtering system according to another embodiment of the invention including a float and a weighted sleeve.

### DETAILED DESCRIPTION OF THE INVENTION

The following description is intended to provide the reader with a better understanding of the invention. The description is not intended to be limiting concerning any element not otherwise limited within the claims.

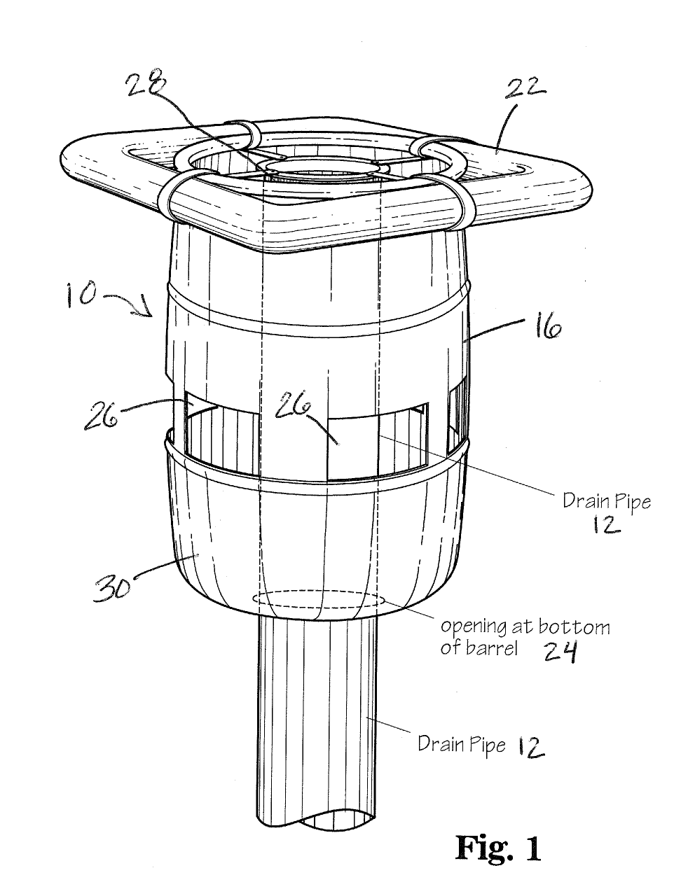

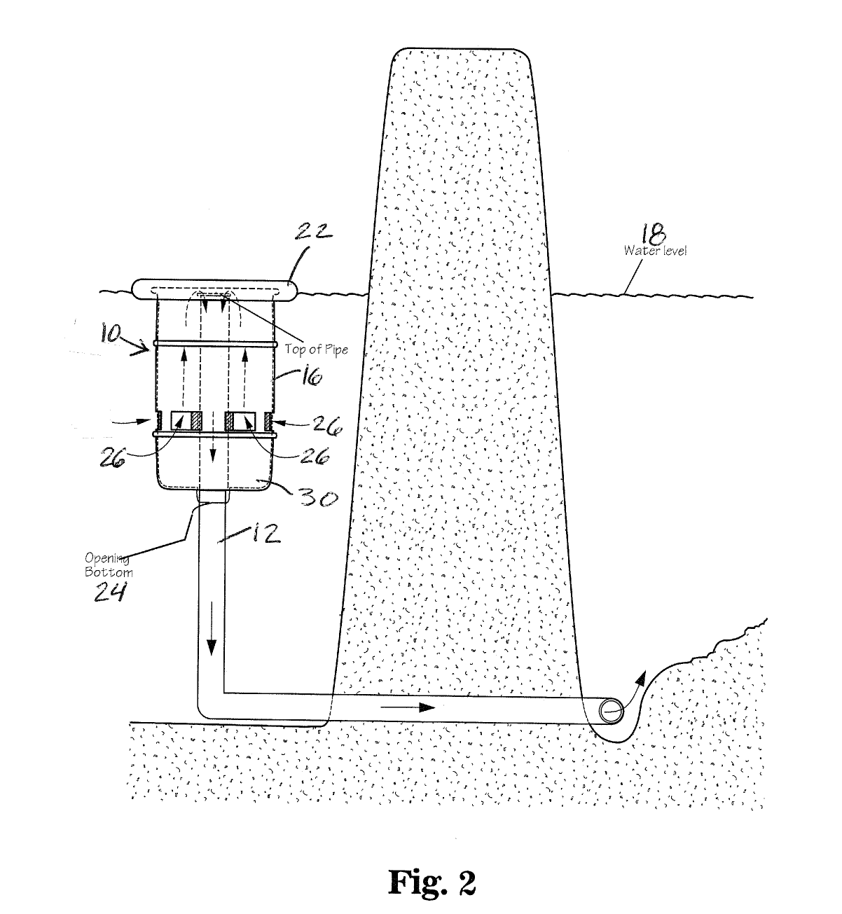

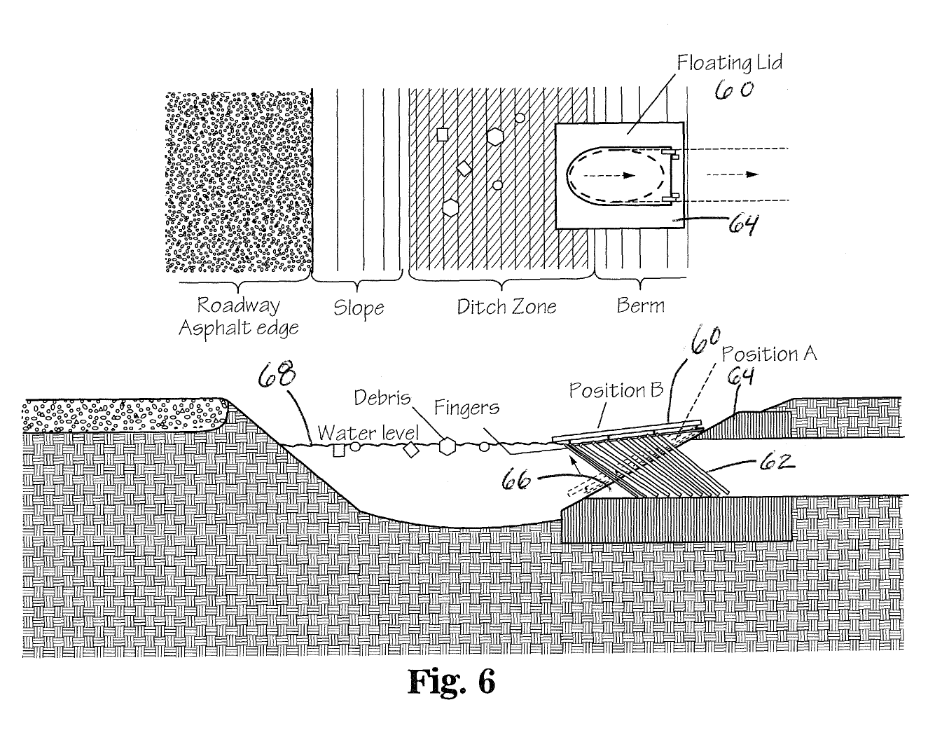

The present invention discloses a water leveling and filtering system. The system includes a guard 10 in combination with an overflow pipe 12, spillway 64, or other water level drain system. The guard 10 may comprise a debris trap formed of a sleeve 16 having an open bottom and an open top as shown in FIGS. 1 and 2. Or, in another embodiment, the guard may comprise a combination gate 60 with strakes 62 as shown in FIG. 6. The guard 10 floats and manages any debris flowing toward and about the outside of the guard to keep the outside water system clean and to make management of the debris easier to accomplish when water levels are low.

As shown in FIGS. 1, 2, and 7, the sleeve 16, 50 may include a collar 22 for stability and flotation of the sleeve about the pipe 12. The collar 22 may define the top of the sleeve 16, and the collar may contain floatation material such as foam, air, or other material having less mass than the surrounding water. Foam within the collar can prevent the sleeve from sinking too low if there is a hole or damage to the collar. The collar 22 is laterally held in place by the pipe 12 centrally located within the cylindrical interior of the sleeve 16. The collar 22 is placed about the pipe 12 and moves upward and downward about the pipe with the water level 18. Meanwhile, the depth of the sleeve 16 and weight thereof may be extended to prevent the collar 22 from lifting the sleeve from the drain pipe 12. Otherwise, the floating collar 22 may cause the guard 10 to be picked up and carried away from the overflow pipe 12.

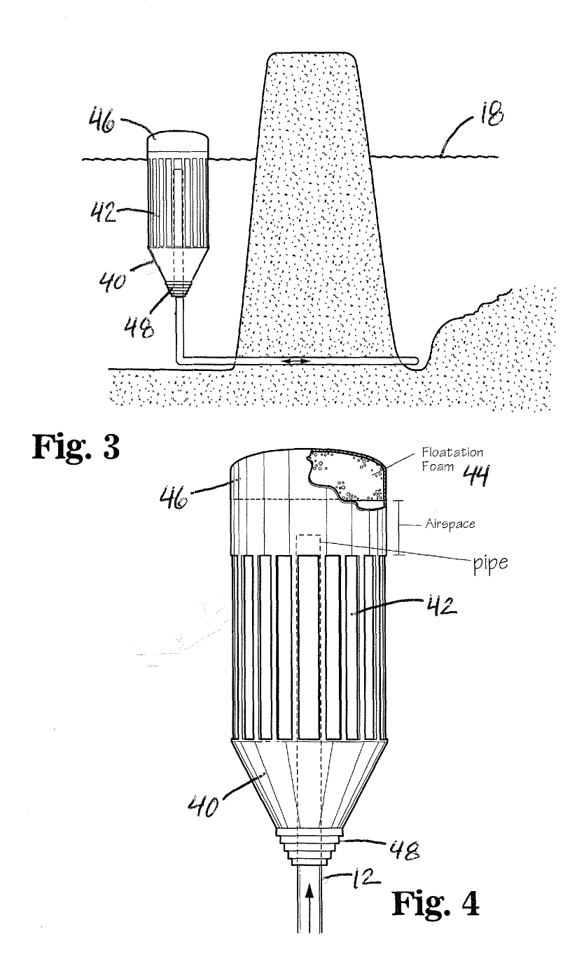

The sleeve 16 may be configured to allow water to enter from a bottom opening 24 or side openings 26 shown in FIG. 1. The sleeve 16 may rise with the water level 18 to exceed the height of the drain pipe 16. The sleeve 16 may be configured to rise above the drain pipe in the water system always, whereby the sleeve will rise via the floatation means to an increasing level of the upper collar or portion being above the fixed pipe 12. For side entry of water, slots 42 may be cut out below the desirable water level 18 on the sleeve 40, 50 as shown in FIGS. 3, 4 and 7. The water may come in from the side of the combined stack of the sleeve 16 and collar 22, while the sleeve will remain upright and float up and down via the floatation and balance provided by the combination of the sleeve and the collar. The floatation properties of the collar can be combined into the sleeve 40 to create a unit during manufacture to streamline the apparatus of the system as shown in FIGS. 3 and 4. The sleeve 40 minimizes snags or clogs. Foam 44 or air may fill the interior cavity of an upper portion 46 of the sleeve 40.

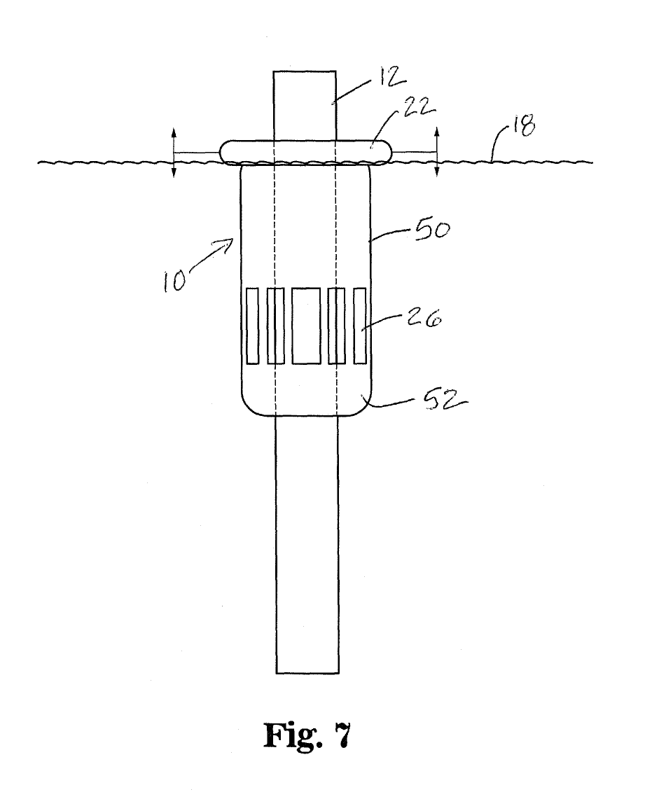

The embodiments include configuration of the sleeve 16, 40, 50 with a lower collar, floatation means, or ballast means about a mid or lower portion of the sleeve. The embodiment may provide foam in a lower collar, or other floatation means, to improve floatation of a sleeve. Additional floatation means may be desirable when the sleeve comprises a material having greater mass for durability. In another embodiment ballast weight, such as a concrete filling in the bottom portion of the body of the sleeve 16, 40, 50, may be provided to improve the depth of the sleeve. Such weighted portion may comprise a filling within a formed bottom portion of the sleeve 16, 40, 50, such as the bottom portion 52 shown in FIG. 7. In some cases, the weight may help to stabilize the guard 10, for example when the sleeve 16, 40, 50 comprises a lightweight plastic material. Lightweight material may cause the sleeve to be unstable or remain at a higher water level than desired without the additional weight.

As shown in FIGS. 1 and 2, a filter 28 on the top of the drain pipe 12 filters water flowing into the drain pipe. The filter screens out smaller debris entering the sleeve 16 from the pipe. Debris can be cleaned from the filter 28 when water levels are low. The combination of the filter 28 and sleeve 16 prevent fish from leaving the water system. Further, the drain pipe 12 itself can be modified to include grooves, or filtering means, integrated therein for water flow.

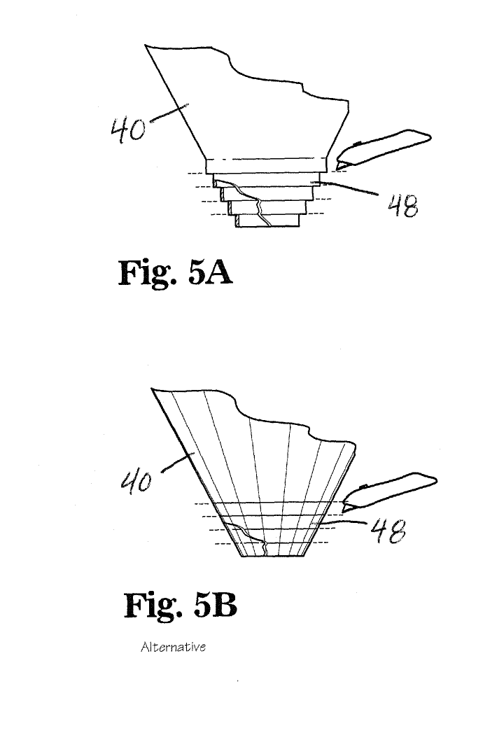

The sleeve 40 may include slots 42 as illustrated in FIGS. 3 and 4 to permit substantial amounts of water to enter the sleeve from the sides. The adaptation of the sleeve 40 to the pipe size permits the sleeve to remain more securely on the pipe 12 and move efficiently up and down with water levels. Further, the slots 42 provide for filtering of large debris from entering the interior of the sleeve 40 or pipe 12. The top portion 46 of the sleeve 40, in one embodiment, is about one foot in length and is solid in the embodiment of FIG. 3. The solid top portion 46 promotes movement of garbage around and over the drain pipe. Meanwhile, the slots 42 or grooves cut in the mid to lower portion of the sleeve 40 promotes water flow. The sleeve 40 may narrow gradually toward the bottom and terminate in a fitting 48 for attachment of the sleeve 40 to a fixed drain pipe 12. Typical drain pipes will be six to eight inches in diameter. As shown in FIGS. 5A and 5B, the bottom portion of the sleeve 40 may comprise the fitting 48 and be adapted to fit on any typical sized pipe 12 used in a water system. The sleeve 40 may be cut to the appropriate size before installation as depicted to adapt the sleeve to the pipe.

The embodiment of FIG. 6 adapts the apparatus of the system to a roadway drain system. The embodiment comprises a guard with a gate 60 formed by a floating lid and attached strakes 62. The revised system separates trash from the water entering the drain system via a spillway 64. When water flows, the gate 60 rests on the drain opening 66 is in an initial closed position. The drain opening 66 may be reconfigured or designed with a slanted top to accommodate the gate 60 and the activation of floatation of the gate when the water rises. The gate 60 stays closed until water covers the spillway 64 or drain path it to a certain depth. For instance, water may drain from a roadway down a slope to a ditch zone where water and trash begin to collect at the drain opening 66 to the spillway system. All the trash, plastic and other debris floats. The floatation activator reacts to the water depth and pulls the gate 60 below the water open to allow water to flow through while most trash and debris floats harmlessly without entering the drain system. Lifting the gate 60 reveals the strakes 62 comprised of fingers attached to the gate inwardly toward the drain opening 66 from the bottom side of the gate. The strakes 62 attach to the bottom surface of the gate and extend downward and outward from the bottom. These strakes extend toward the interior of the drain opening 66 from the gate. The strakes keep any trash that does not float from entering the opening once the water level 68 opens the gate. Operators collect trash and debris that floats on the water, after a flood event once the water recedes. Operators may attach a trap net behind or about the guard apparatus to trap floating trash and debris. Further, operators may install a fence like trash rack as used in the past in front of the gate and the opening of the drain area to prevent very large debris such as logs from entering below the gate 60.

These and other embodiments may be apparent to those skilled in the art and within the scope of the invention.

1. A water leveling and filtering system comprising:
a guard;
said guard comprising a sleeve;
said sleeve including a bottom and a top;
a pipe with a top opening for drainage of water and fixed within water with a water level;
said sleeve arranged about the fixed drainage pipe via an opening in the sleeve bottom and an opening in the sleeve top for longitudinal movement of the sleeve on the pipe;
said sleeve floats in the water and an upper portion of the said sleeve remains above the water level; and
said sleeve includes an opening in the bottom or side below the water level that permits the flow of water through the sleeve.
